(19) United States
(12) Patent Application Publication
(10) Pub. No.: US 2023/0011806 A1
(43) Pub. Date: Jan. 12, 2023

(54) WORKFLOW GENERATION AND PROCESSING

(71) Applicant: Verify, Inc., Irvine, CA (US)

(72) Inventors: John Adelmann, Pinckney, MI (US); Shana Deering, Haslet, TX (US); Charlie Stevenson, North Richland Hills, TX (US)

(73) Assignee: Verify, Inc., Irvine, CA (US)

(21) Appl. No.: 17/862,135

(22) Filed: Jul. 11, 2022

Related U.S. Application Data
(60) Provisional application No. 63/220,403, filed on Jul. 9, 2021.

(51) Int. Cl. G06Q 10/06

(52) U.S. Cl. CPC G06Q 10/0633

(57) ABSTRACT

Computing systems methods, and non-transitory storage media are provided for obtaining constraints of an entity, generating or obtaining specifications corresponding to the constraints, and generating a workflow based on responses to a questionnaire directed to one or more potential sources, wherein the questionnaire is derived based on the specifications, and a source of the one or more potential sources is selected to be associated with the workflow. The constraints include quality standards, quantity requirements, and a timing characteristic associated with physical goods.

### CROSS REFERENCE TO RELATED APPLICATIONS

This application claims the benefit under 35 U.S.C. § 119(e) of U.S. Provisional Application Ser. No. 63/220,403, filed Jul. 9, 2021, the content of which is incorporated by reference in its entirety into the present disclosure.

### FIELD OF THE INVENTION

This disclosure relates to generating a workflow in order to fulfill, resolve, or satisfy certain constraints or requirements for an entity, along with mechanisms to improve or augment existing capabilities of addressing a workflow.

### BACKGROUND

Current mechanisms of fulfilling certain standards, constraints and/or requirements (hereinafter “constraints”) for an entity, such as pertaining to acquiring physical goods or services, may be inadequate because they largely rely on a one-size-fits-all approach. Such an existing approach erroneously assumes that different entities have overlapping and/or similar constraints while disregarding the unique constraints for the entity. As one particular example, two entities may have different constraints regarding factors or criteria such as quality standards, quantity requirements, timeliness requirements, and other requirements. In particular, one constraint that may be considered for one entity may be of negligible or no weight for a different entity. Therefore, a mechanism that is tailored to the particular constraints of each entity would improve an ability to address the particular needs and constraints for that particular entity by harnessing existing resources more directly towards the particular constraints for that particular entity. Additionally, such a mechanism increase an awareness of the particular constraints to be addressed for different entities. This increased awareness may be a catalyst that results in enhancements or refinements of related operations such as operations that produce and/or supply the goods or services.

### SUMMARY

Various examples of the present disclosure can include computing systems, methods, and non-transitory computer readable media configured to perform: obtaining constraints of an entity, wherein the constraints are associated with quality standards, quantity requirements, and a timing associated with physical goods (e.g., a receipt or delivery of the physical goods); generating or obtaining specifications corresponding to the constraints; and generating a workflow based on responses to a questionnaire directed to one or more potential sources, wherein the questionnaire is derived based on the specifications, and a source of the one or more potential sources is selected to be associated with the workflow. The potential source has provided responses that conformed to the specifications to a closest degree or extent, compared to the other of the one or more potential sources.

In some examples, the specifications may comprise, or be manifested as, desired or required conditions or guidelines to be conformed to for the entity, and/or categories associated with the desired or required conditions.

In some examples, the computing systems, methods, or non-transitory computer readable media may further perform compiling, combining, or integrating the specifications into a template which may be specifically linked to the workflow and/or to the entity. The specifications and/or the template may be stored in a database and siloed from specifications and/or templates corresponding to other entities. The template may include respective weights or weightings associated with each of the specifications, which may indicate degrees of importance of each of the specifications.

In some examples, the computing systems, methods, or non-transitory computer readable media may further perform generating or receiving a scoring criteria to evaluate an operation or an execution (hereinafter “execution”) of the workflow with respect to the specifications, which may indicate a degree of conformance of the execution of the workflow to the specifications. The computing systems, methods, or non-transitory computer readable media may further evaluate the execution of the workflow based on the scoring criteria.

In some examples, the computing systems, methods, or non-transitory computer readable media may further perform determining any of the specifications corresponding to one or more scores within the scoring criteria of below respective threshold levels, and in response to the determination of the any of the specifications corresponding to one or more scores within the scoring criteria of below respective threshold levels, transmitting an alert to the source and to a second source designated or assigned to at least a portion of the workflow and to which a score of below the threshold level is attributed.

In some examples, the computing systems, methods, or non-transitory computer readable media may further perform identifying any downstream sources to the second source to which the score of below a threshold level is attributed.

In some examples, the computing systems, methods, or non-transitory computer readable media may further perform determining a particular factor correlated to or causing the score to be below a threshold level, and determining or suggesting a resolution corresponding to the particular factor. The resolution may be determined or suggested for the second entity or for the any downstream entities. The computing systems, methods, or non-transitory computer readable media may further perform transmitting the resolution to the second source or a downstream source relative to the second source, which may supply, transmit, and/or produce goods, intermediate components, and/or raw materials to or for the second source.

In some examples, the computing systems, methods, or non-transitory computer readable media may further receive an indication that the second source or the downstream source to the second source accepts or initiates the resolution, and evaluates an execution of the resolution to assess an efficacy of the determined resolution and a degree of conformity of the second source or the downstream source with the resolution.

In some examples, the computing systems, methods, or non-transitory computer readable media may further determine or receive a modification of a specification of the specifications. The computing systems, methods, or non-transitory computer readable media may reflect the modification within the template and accordingly update the scoring criteria, and evaluate an execution of the operation of the workflow based on the updated scoring criteria.

In some examples, the computing systems, methods, or non-transitory computer readable media may receive an update to a weight corresponding to one of the specifications, and evaluate an execution of the workflow based on the update to the weight.

These and other features of the computing systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings. Any principles or concepts illustrated in one figure may be applicable to any other relevant figures. For example, principles illustrated in FIG. 1 may also be applicable to any of FIGS. 2-12 and vice versa.

FIG. 1 illustrates an example environment, in accordance with various examples, of a computing system that a computing system that generates, processes, and/or executes a workflow to fulfill constraints for an entity.

FIG. 2 illustrates, in accordance with various examples, a questionnaire being used to divulge further details and nuances related to a request, and used to determine a potential source that conforms most closely with the constraints for the entity to be associated with the workflow.

FIG. 3 illustrates, in accordance with various examples, that sub-sources that are downstream of potential sources are also assessed in determining a potential source to be associated with the workflow.

FIG. 4 illustrates, in accordance with various examples, a performance evaluation of a source associated with the workflow.

FIG. 5 illustrates, in accordance with various examples, a performance evaluation of one or more sub-sources and/or a sub-sub-source associated with the workflow.

FIG. 6 illustrates, in accordance with various examples, an output of a suggestion to address a performance level falling outside of a permitted threshold boundary or range.

FIG. 7 illustrates, in accordance with various examples, a reevaluation process following an implementation of a suggestion.

FIGS. 8-9 illustrate, in accordance with various examples, a change in a weight of one or more specifications, a new specification, and/or a modification of an existing specification, and subsequent reevaluation of a performance of a source associated with the workflow.

FIG. 10 illustrates, in accordance with various examples, a redetermination of a potential source or a source.

FIG. 11 illustrates, in accordance with various examples, a change of a potential source or of a source which results in generation of a new and/or updated specification and/or template.

FIG. 12 illustrates, in accordance with various examples, a generation and/or an execution of a workflow.

FIG. 13 illustrates, in accordance with various examples, internal storage within a data source or database.

FIG. 14 illustrates, in accordance with various examples, an example template or example specifications.

FIG. 15 illustrates, in accordance with various examples, an example user interface that provides contextual details regarding aspects of the workflow.

FIG. 16 illustrates a flowchart of an example method consistent with FIGS. 1-15, embodied in a computing component.

FIG. 17 illustrates a flowchart of an example method consistent with FIGS. 1-15, embodied in a computing component.

FIG. 18 illustrates a block diagram of an example computer system in which any of the embodiments described herein may be implemented.

### DETAILED DESCRIPTION

Current attempts to address fulfillment of physical goods and/or of services are largely limited by failure to adequately account for unique requirements or desires of an entity that is requesting the physical goods and/or services. This shortcoming is attributed in part to a failure to understand or decipher the specific requirements or desires, and nuances thereof, of such an entity. This shortcoming also results in a failure to recognize, or be cognizant of, feedback regarding such a fulfillment process, which would otherwise have been able to improve such a process. These deficiencies, among others, are a testament that a gap exists between a request for fulfillment and an actual execution of such a fulfillment.

In an effort to bridge this gap, a new approach aims to provide deeper understanding and contextual awareness during a fulfillment process by not only passively ingesting or inputting requirements or desires of an entity, but rather, performing further analysis of the requirements or desires, and further investigations and verifications of whether the fulfillment process actually satisfies the requirements or desires of the entity. Such further investigations not only improve a current fulfillment process but also improve a mechanism to address deficiencies of fulfillment processes in general.

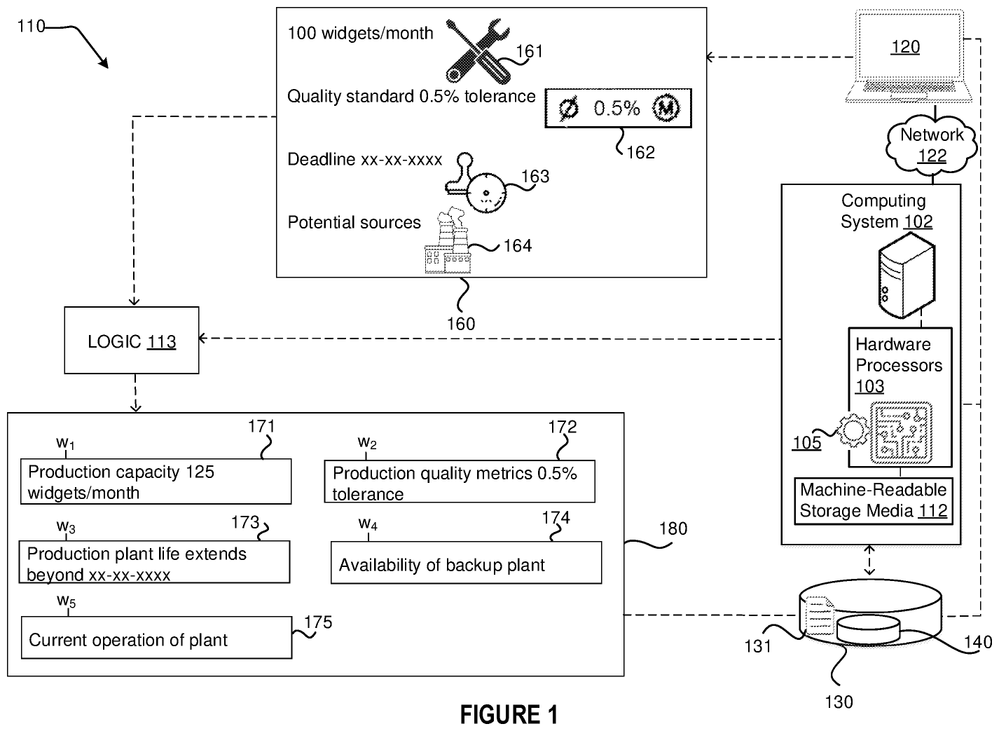

FIG. 1 illustrates an example environment or scenario (hereinafter “environment”) 110, in accordance with various embodiments, of a computing system that generates, processes, and/or executes a workflow to fulfill, resolve, or satisfy (hereinafter “fulfill”) constraints for an entity. The constraints may be associated with an acquisition of physical goods and/or services. For example, the constraints may specify, without limitation, quantity requirements, a rate and/or a frequency of receipt or delivery, quality standards, and/or timeliness requirements.

The example environment 110 can include at least a computing system 102 and at least one computing device 120. In general, the computing device 120 may be operated by an entity such as a user. The user may submit a request or query (hereinafter “request”) 160 through the computing device 120 for a fulfillment of physical goods and/or services. For example, the request 160 may specify a number or rate of delivery or receipt of products, items, or goods 161 (hereinafter “goods 161”), a quality standard 162 which may encompass a tolerance of the goods 161, and/or a standard such as ISO (International Organization for Standardization), MIL (United States Military Standard), AS (Aerospace Standard), and a deadline or desired date (hereinafter “deadline”) 163 by which the goods 161 are to be received or delivered. Other parameters or characteristics of the request 160 may include a level of stability of a source from which the goods 161 are obtained, preventative maintenance measures associated with the source, a level of experience associated with the source, a current backlog associated with the source, a risk level associated with the source, geographical restrictions of receipt and/or delivery, a level of human resources available, a production capacity and/or capability, and supply chain parameters of the source, or of sub-sources downstream of the source which may distribute, produce, warehouse, and/or supply any portion of the goods and/or raw materials thereof. In some examples, the user may provide annotations, feedback, or modifications to any of the outputs, inputs, and/or intermediate results received at the computing device 120, and generated from the computing system 102. In some examples, the computing device 120 may visually render any outputs generated from the computing system 102, such as details of an operation, details about different sources, for example, regarding not only goods supplied to the entity but also supplied to other entities. For example, the details about different sources may encompass a predicted or scheduled amount of goods of a same type and/or a related or different type to different other entities within a common timeframe that the entity is scheduled to receive the goods. In general, the user can interact with the computing system 102 directly or over a network 122, for example, through one or more graphical user interfaces and/or application programming interfaces.

The computing system 102 and the computing device 120 may each include one or more processors and memory. Processors can be configured to perform various operations by interpreting machine-readable instructions, for example, from a machine-readable storage media 112. The processors can include one or more hardware processors 103 of the computing system 102. In some examples, one or more of the hardware processors 103 may be combined or integrated into a single processor, and some or all functions performed by one or more of the hardware processors 103 may not be spatially separated, but instead may be performed by a common processor.

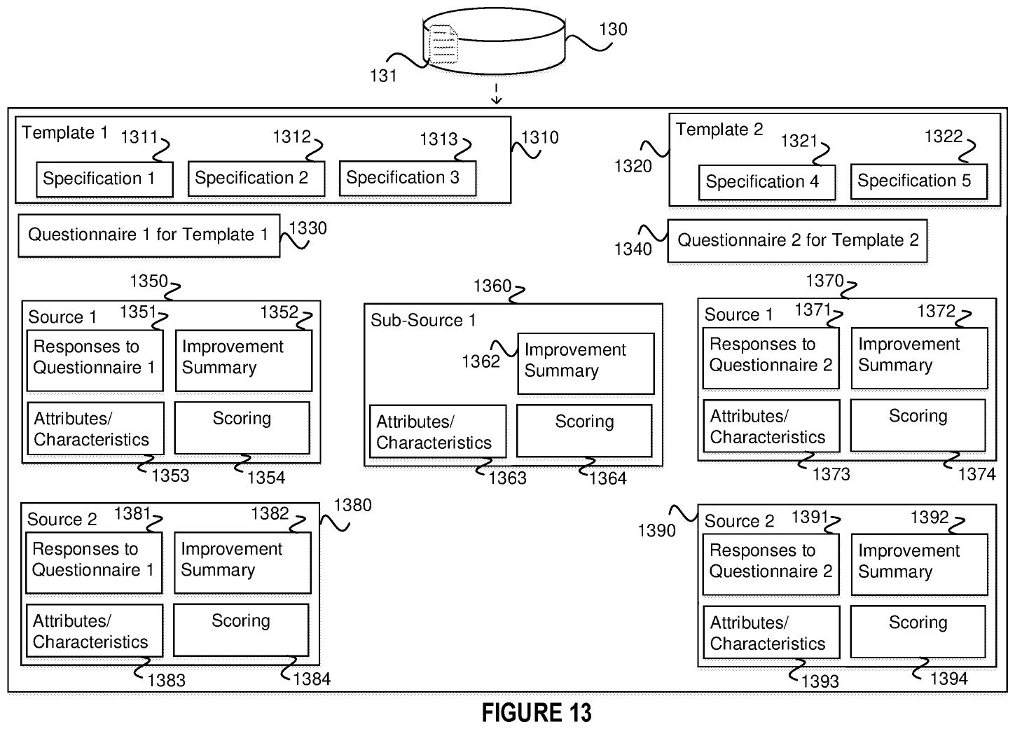

The computing system 102 may be connected to or associated with one or more data sources, databases, or data stores (hereinafter “data sources”) 130, which may be at or associated with a back end. An example data source 130 is further illustrated in FIG. 13. The data sources 130 may store information of the request 160, of specifications 171, 172, 173, 174, and 175 generated or derived from the request 180, and/or of a template 180, and/or of metadata or contextual information associated with the aforementioned, in a siloed manner such that other entities cannot access this stored information in order to protect privacy of the entity. The specifications 171, 172, 173, 174, and/or 175 may be nonspecific or specific to the needs and/or desires of the entity. The specifications 171, 172, 173, 174, and/or 175 may be characterized by a topic and/or a category. For example, the aforementioned information may be stored in a segment 140 segregated from other portions used to store information of other entities. The data sources 130 may be indexed by an index 131, which may categorize the aforementioned information to facilitate searching. Searching for the specifications 171, 172, 173, 174, and/or 175 may be via topic, category, or keyword, among other characteristics.

Although one segment 140 is shown for purposes of simplicity, the data sources 130 may be understood to include multiple segments. Each segment may be particularly tailored to or restricted to storage and management of information or resources associated with a specified entity. Yet other segments may be specific to each source, such as storing characteristics of each source and/or improvement summaries or outlines (hereinafter “improvement summaries”) of each source. The improvement summaries may encompass action items, short-term and/or long-term, to address for each entity to improve an overall performance, not only for a purpose of meeting the entity's needs or desires but also targeted towards overall improvement for other entities.

Such segregation of the resources in different segments may be desirable because access to, dissemination, and/or release of the information from one segment is to be determined and managed separately from those resources in other segments, and only specific entities may have access to each of the segments. Therefore, the demarcation of information within the data sources 130 into segments, such as the segment 140, provides clear delineations, classification levels and/or access constraints of each of the segments.

The hardware processors 103 may further be connected to, include, or be embedded with logic 113 which, for example, may include protocol that is executed to carry out the functions of the hardware processors 103. In general, the logic 113 may be implemented, in whole or in part, as software that is capable of running on one or more computing devices (e.g., the computing device 120) or systems such as the hardware processors 103, and may be read or executed from the machine-readable storage media 112. In one example, the logic 113 may be implemented as or within a software application running on one or more computing devices (e.g., user or client devices such as the computing device 120) and/or one or more servers (e.g., network servers or cloud servers). The logic 113 may, as alluded to above, perform functions of, receiving the request 160, formulating or generating the specifications 171, 172, 173, 174, and/or 175 based on the request 160, and generating and/or executing a workflow for fulfilling the request. In some examples, the specifications 171, 172, 173, 174, and/or 175 may be generated manually or automatically. If generated automatically, the computing system 102 may include an autocomplete feature, to suggest completed specifications following receipt of a partial input.

The specification 171 may indicate that a production capacity of a source is to be at least 125 widgets per month in order to satisfy the quantity requirement of 100 widgets per month. The specification 172 may further indicate that production quality metrics are to have at most a tolerance of 0.5% in order to satisfy the quality standard 162. The specification 173 may indicate that a production plant is expected to last beyond the deadline 163, to avoid a chance that delivery or receipt would end prematurely. The specification 174 may indicate that a backup plant of or associated with the source is required or desired, to mitigate a possibility of failure to receive goods if a primary plant fails. The specification 175 may indicate a further status of a current operation of a plant at the source, for example, its current operating capacity and/or capability. In some examples, the current operating capacity may refer to an amount of goods and/or services presently deliverable by a source, based, for example, on human power, machines, and/or facilities. Meanwhile, the capability may refer to an amount of goods and/or services deliverable by that source while taking into account other factors such as those related to feasibility. Those factors may encompass historical performance, solvency, and/or integrity of the source. The specifications 171-175 are intended to be merely exemplary and non-limiting. In some examples, any or all of the specifications 171-175 may be combined into a template 180, which may further include weights w₁, w₂, w₃, w₄, and w₅ indicating relative importances associated with each of the specifications, respectively. Each of the specifications 171-175 may belong to a particular category. The specifications 171-175, along with the respective weights, may be a basis upon which a source for the goods and/or services is selected, and further be a standard to evaluate the execution of the workflow. The specifications 171-175 may be generated or derived automatically by the logic 113 and/or manually. As alluded to, the specifications 171-175 may be either specific or non-specific for the entity. Thus, the specifications 171-175 may encompass a combination of specific and nonspecific criteria or standards. Any or all of the specifications 171-175 may be independent from other specifications.

The computing system 102 may include, or be associated with, an application programming interface (API) 105 which may facilitate connection with external systems. The external systems may include a system or architecture associated with a source. For example, the API may connect with an enterprise resource planning (ERP) system associated with a source, such that relevant information such as a profile and/or specifications 171-175 of the entity may be transferred to the ERP system without duplicating the relevant information to other portions of the source.

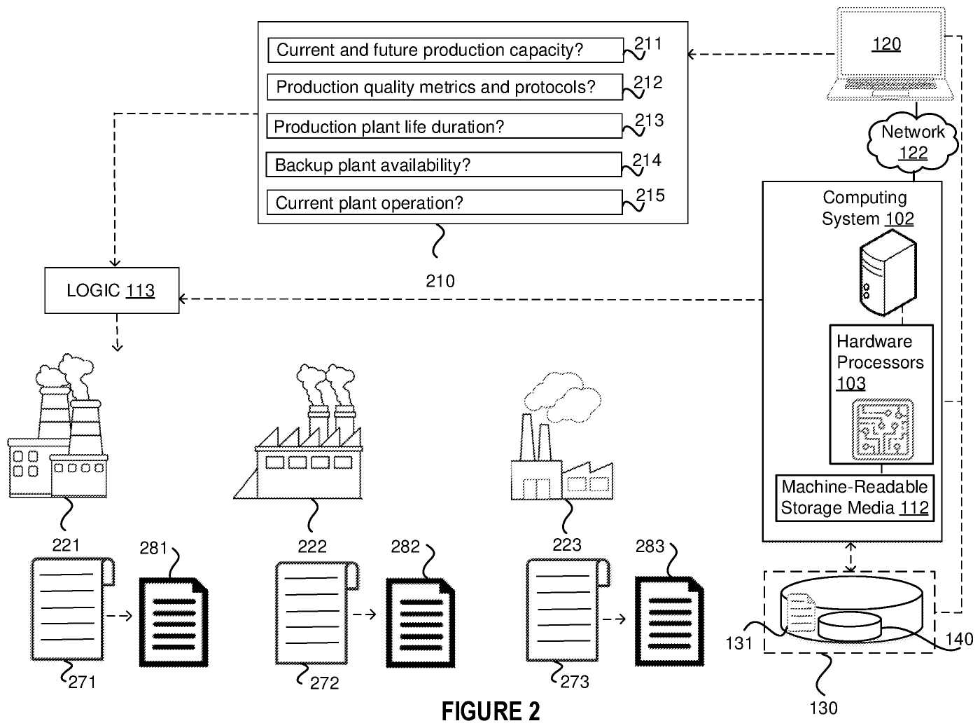

FIG. 2 illustrates that a questionnaire, as generated from the specifications 171-175 and/or the template 180, may uncover further details and nuances related to the request 160. In FIG. 2, a questionnaire 210 may pertain to, and address the request 160. The questionnaire 210 may include questions 211, 212, 213, 214, and/or 215, and be directed to multiple potential sources 221, 222, and 223 that potentially may at least partially distribute, produce, warehouse, and/or supply any portion of the goods, components, and/or raw materials thereof, which may fulfill the request 160. Although three potential sources are illustrated in FIG. 2, any number of potential sources may exist. The questions 211, 212, 213, 214, and/or 215 may be generated manually or automatically. If generated automatically, the questions 211, 212, 213, 214, and/or 215 may be generated using one or more machine learning components, models, or algorithms (hereinafter “components”). The machine learning component may be trained to determine one or more machine learning weights (as distinguished from weights w₁, w₂, w₃, w₄, w₅ illustrated in FIG. 1) corresponding to characteristics or attributes from the specifications 171-175 and/or from the template 180, such as, without limitation, qualitative characteristics (e.g., availability of backup plant), quantitative characteristics (e.g., 125 widgets per month), weights w₁, w₂, w₃, w₄, w₅ corresponding to each of the specifications 171-175, plant or facility-specific aspects, and/or quality control or inspection aspects. In some examples, the weights w₁, w₂, w₃, w₄, w₅ may be correlated to a number of questions directed to each of the respective specifications 171-175. The training may encompass supervised training, in which at least a subset of training data includes one or more proper questions and/or keywords, terms, or phrases to be included in the questions, for each corresponding specification or combination of specifications, and/or template. The specification(s) and/or template may be provided as input and the one or more machine learning components can adjust the one or more machine learning weights based on the corresponding one or more proper questions and/or keywords, terms, or phrases. Additionally or alternatively, the training may encompass using at least two subsets of training data sequentially or in parallel. A first subset of training data may include scenarios in which two different specifications and/or templates as input results in an output have common and/or overlapping questions. A second subset of training data may include scenarios in which two different specifications and/or templates as input results in an output have non-overlapping questions. Alternatively or additionally, an additional subset (e.g., a third subset of training data) may include scenarios that the machine learning components incorrectly inferred, determined, or predicted, or scenarios having threshold similarities to the examples that were incorrectly inferred by the machine learning components. In such a manner, the machine learning components may be improved by retraining on examples in which the machine learning components performed worst. Another aspect of training may be feedback, for example provided by a user such as a user of the computing device 120, regarding outputs from the machine learning components while the machine learning components are actually operating.

The potential sources 221, 222, and 223 may be automatically selected by the computing system 102 or indicated as candidates to fulfill the request 160 via the computing device 120, for example, as part of the request 160 and listed under potential sources 164. The potential sources 221, 222, and 223 may encompass plants and/or facilities that may at least partially produce or supply the goods 161. A question 211 may concern current and future production capacity or capability of each of the potential sources 211, 222, and 223. A question 212 may concern production quality metrics and protocols of each of the potential sources 211, 222, and 223, such as tolerances permitted, historical quality metrics of actual products made, and/or protocols such as quality control and/or validation protocols. A question 213 may concern a duration of a plant at the source that produces the goods. For example, if the plant is scheduled or predicted to shut down before the deadline 163, then the potential source associated with the plant may be disqualified. A question 214 may be regarding an availability of a backup plant, in case a primary or current plant unexpectedly fails. A question 215 may be regarding an operating status of a current plant, such as, its current operating capacity and/or capability. Yet other questions may pertain to a proportion of goods that each of the potential sources 221, 222, and 223 outsource from external sources.

The questionnaire 210 may be applied to and/or asked to each of the potential sources 221, 222, and 223 to obtain answers or responses (hereinafter “responses”) 271, 272, and 273, respectively. The responses 271, 272, and 273 may be inputted or ingested into the computing system 102, and evaluated to determine an extent to which they comply with the specifications 171-175. In some examples, a response of the responses 271, 272, and 273 that conforms with the specifications 171-175 to at least a threshold extent, and/or a response of the responses 271, 272, and 273 that conforms most closely with the specifications 171-175 may be a basis to select a potential source. For example, if the response 271 conforms most closely with the specifications 171-175 and/or conforms to at least a threshold extent, then the potential source 221 may be selected to fulfill the request 160. In some examples, the potential source 221 may be selected following confirmation by the device 120.

The responses 271, 272, and 273 may be stored or logged in a data store, such as in the data sources 130. The responses 271, 272, and 273, and/or a summary or condensed version thereof, may further be provided or displayed at the computing device 120. Additional analysis or commentary regarding the responses 271, 272, and 273 may also be provided at the computing device 120. For example, the additional commentary may encompass long term goals or objectives of the potential sources 221, 222, and 223, and/or levels of interest of the potential sources 221, 222, and 223 in fulfilling the request 160. As a particular example, the additional commentary may indicate that the potential source 221 is uninterested in fulfilling the request 160 due to misalignment with goals, priorities, or objectives of the potential source 221. Thus, if the entity still wishes to select the potential source 221, then the entity may need to modify the request 160 and/or provide an additional explanation of how the request 160 may be aligned with the goals, priorities, or objectives of the potential source 221. The additional commentary may also provide information regarding other scheduled goods of a same or related type that are scheduled or predicted to be delivered to other entities within a common timeframe as a schedule that corresponds to the request 160. For example, if the request 160 specifies a timeframe of delivery or supplying that spans two years, then the information regarding the other scheduled goods may be scheduled or predicted within a timeframe of two years.

Moreover, the responses 271, 272, and 273 may be used to generate improvement summaries 281, 282, and 283 for each of the potential sources 221, 222, and 223, which may delineate specific steps or actions to be taken in order to improve overall performance not only to address the request 160 of the entity, but also overall and to address potential and actual requests by other entities. In some examples, the potential source 221 may be selected based on the assumption that the specific steps or actions within the improvement summary 281 are implemented. The improvement summaries 281, 282, and 283 may be provided to the respective potential sources 221, 222, and 223.

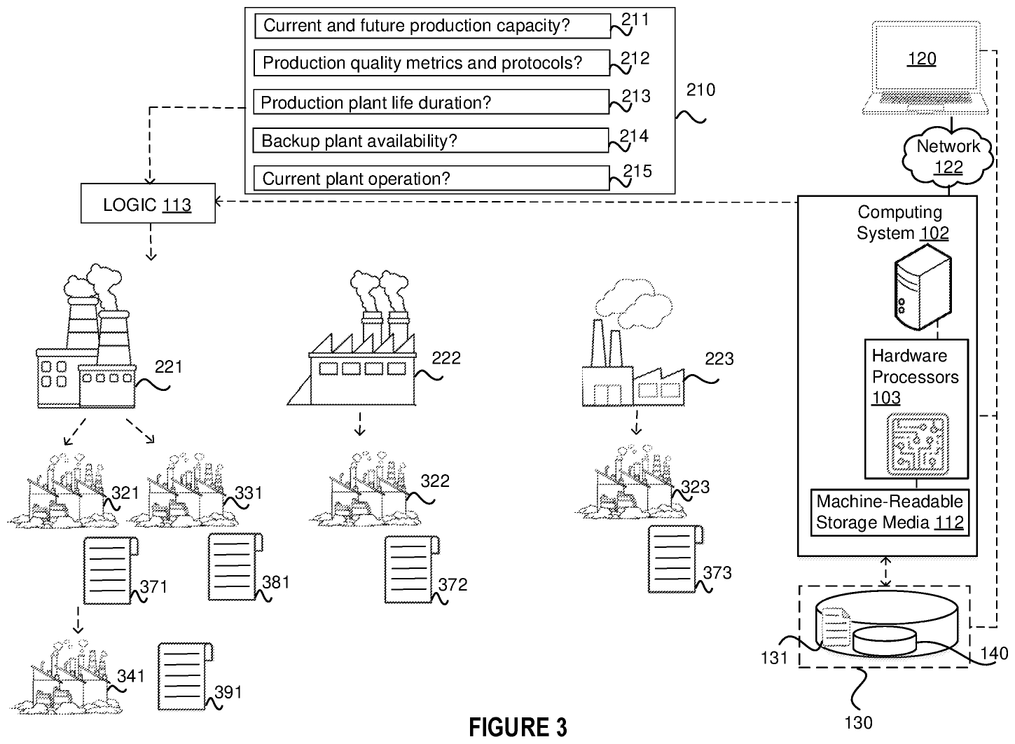

FIG. 3 illustrates that sub-sources that are downstream of the potential sources 221, 222, and 223 may also be assessed to provide a fuller perspective and context to the potential sources 221, 222, and 223, which may provide information of potential vulnerabilities and/or potential causes of issues. The sub-sources may include facilities and/or plants that at least partially distribute, produce, warehouse, and/or supply any of the goods 161, and/or intermediate goods, and/or raw materials associated with the goods 161. In particular, the questionnaire 210, or portions thereof, may be provided or asked to sub-sources 321, 331, 322, and 323, and a sub-sub-source 341. Answers or responses to the questionnaire 210 may be recorded or logged as responses 371, 381, 372, 373, and 391, corresponding to the respective sub-sources 321, 331, 322, and 323, and a sub-sub-source 341. Improvement summaries may be generated and/or provided to each of the sub-sources 321, 331, 322, and 323, in a same or similar manner as the improvement summaries 281, 282, and 283.

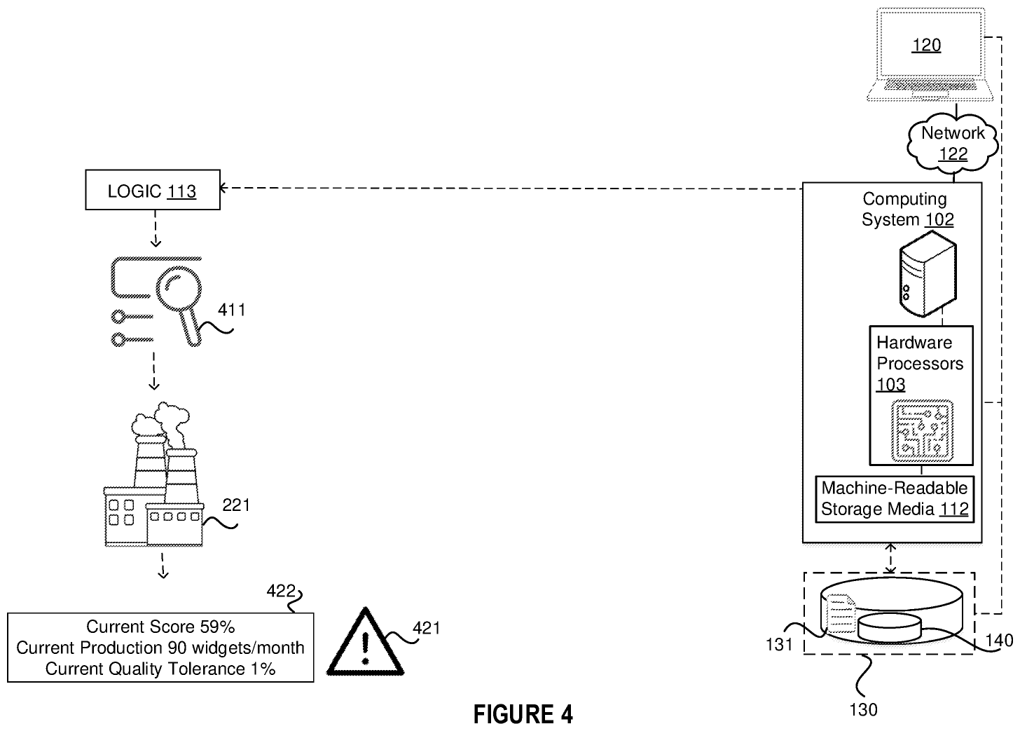

In FIG. 4, after the source 221 is selected to fulfill the request 160, the logic 113 may evaluate a performance of the source 221 using a scoring criteria, which may be defined or generated based on the specifications 171-175 and/or the template 180. The logic 113 may carry out an evaluation process 411 on the source 221 to indicate to what extent, and/or how closely, the source 221 is conforming to the specifications 171-175 and/or the template 180. The evaluation process 411 may, additionally or alternatively, determine an extent to which, and/or an effectiveness of the source 221, in performing the actions or otherwise aligning with the improvement summary 281. A result 422 of the evaluation process 411 may indicate that a current score of the source 221 is below a threshold score, a current production is below a minimum production as specified in the request 160, and a current quality standard is below the quality standard 162. Therefore, the logic 113 may output an alert 421 to the computing device 120 that the performance of the source 221 is below a threshold standard and indicate specific performance parameters or attributes that are inadequate.

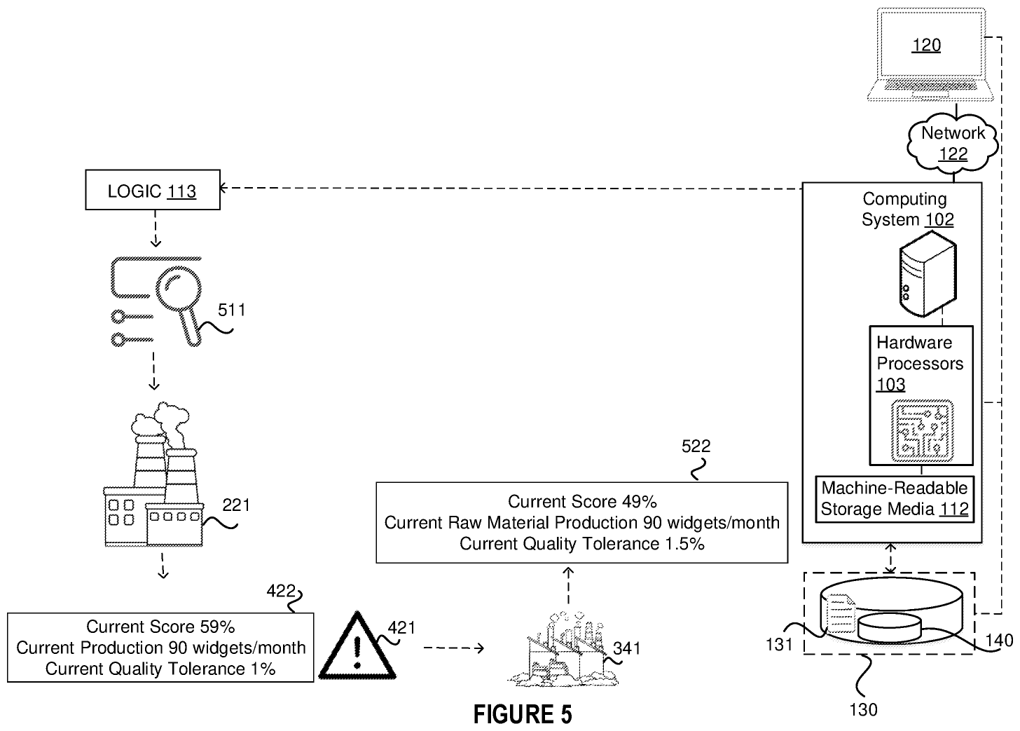

In FIG. 5, the logic 113 may provide further context for the performance of the source 221 by evaluating one or more sub-sources and/or a sub-sub-source, here the sub-sub-source 341. Thus, the logic 113 may uncover additional reasons for the inadequate performance, such as failures of one or more intermediate goods or raw materials producers. In particular, the logic 113 may determine, via an evaluation process 511, a result 522 indicating that the sub-sub-source 341 has a current raw material production equivalent to that of 90 widgets per month and a current quality tolerance of 1.5%, both of which are outside of permitted thresholds. This evaluation process 511 may assist in troubleshooting and/or remedying a situation in which a performance falls short of that specified by the request 160.

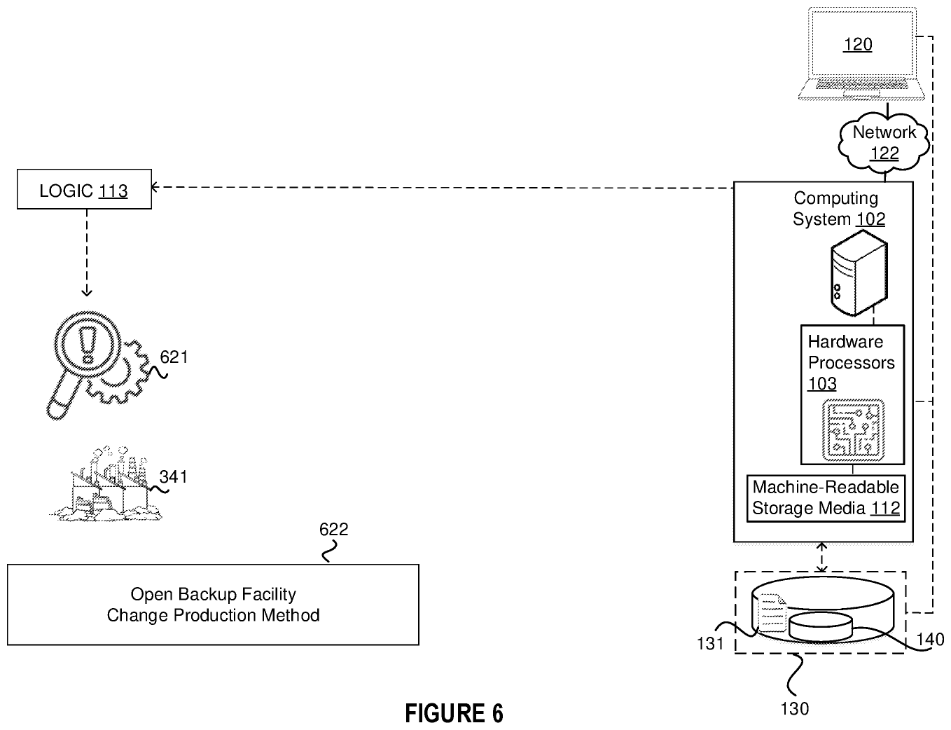

In FIG. 6, the logic 113 may determine, receive, provide, and/or output a suggestion, which may be part of, or separate from, the improvement summary 281, to address either of the situations in FIG. 4 or FIG. 5, in which the performance of the source 221, and/or of the sub-sub-source 341 falls short of a threshold level. In particular, the logic 113 may output a suggestion 622 to be transmitted to the source 221 and/or the sub-sub-source 341 which includes measures such as opening a backup facility, or increasing a production level of a currently operating facility in order to increase monthly output of the goods 161. Additionally, the measures may include changing a production method to one that has higher tolerances or lower errors to meet the 0.5% tolerance threshold.

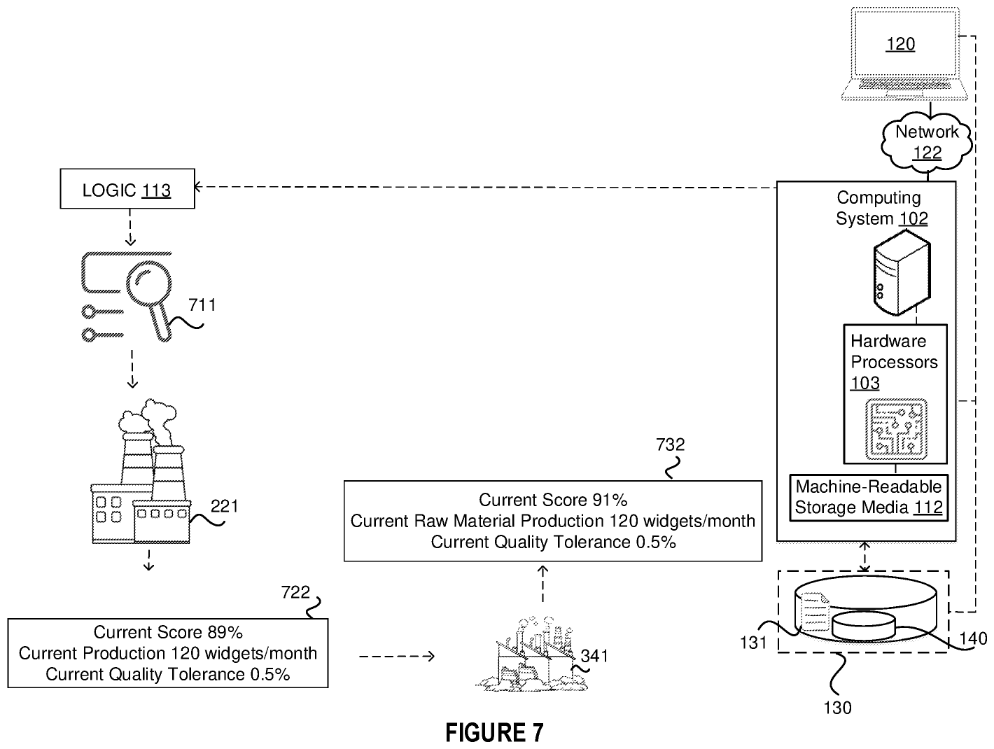

Following the outputting of the suggestion 622, assuming that the sub-sub-source 341 implements the suggestion 622, in FIG. 7, the logic 113 may perform a reevaluation process 711 to reevaluate the source 221 and/or the sub-sub-source 341, to determine whether or not the implementation of the suggestion 622 improves performance, and to what extent performance has been improved. The logic 113 may determine, from the reevaluation process 711, a result 732 that the sub-sub-source 341 has improved its performance such that the current raw material production equivalent and the current quality tolerance are both within permitted bounds as indicated in the request 160. The logic 113 may further determine a result 722 that the change of the sub-sub-source 341 also caused or resulted in an improvement in the performance of the source 221, such that the current production and the quality tolerance is within permitted bounds as indicated in the request 160. Therefore, the logic 113 may confirm that the sub-sub-source 341 was indeed causing inadequate performance of the source 221.

However, if, after implementing the suggestion 622 by the sub-sub-source 341, the performance of the sub-sub-source 341 was still inadequate and/or failed to improve, then the logic 113 may receive a determination of whether, or determine whether, the sub-sub-source 341 implemented the suggestion 622 to an adequate (e.g., at least a threshold) extent. If so, then the logic 113 may determine that a different suggestion may more effective resolve the performance issues of the sub-sub-source. Alternatively, or additionally, if performance improvements of the sub-sub-source still failed to adequately resolve the performance issues of the source 221, then the logic 113 may determine that a different reason, and/or a different sub-source, may be attributed to the performance issues of the source 221. The logic 113 may additionally or alternatively suggest switching away from the source 221 to a different source.

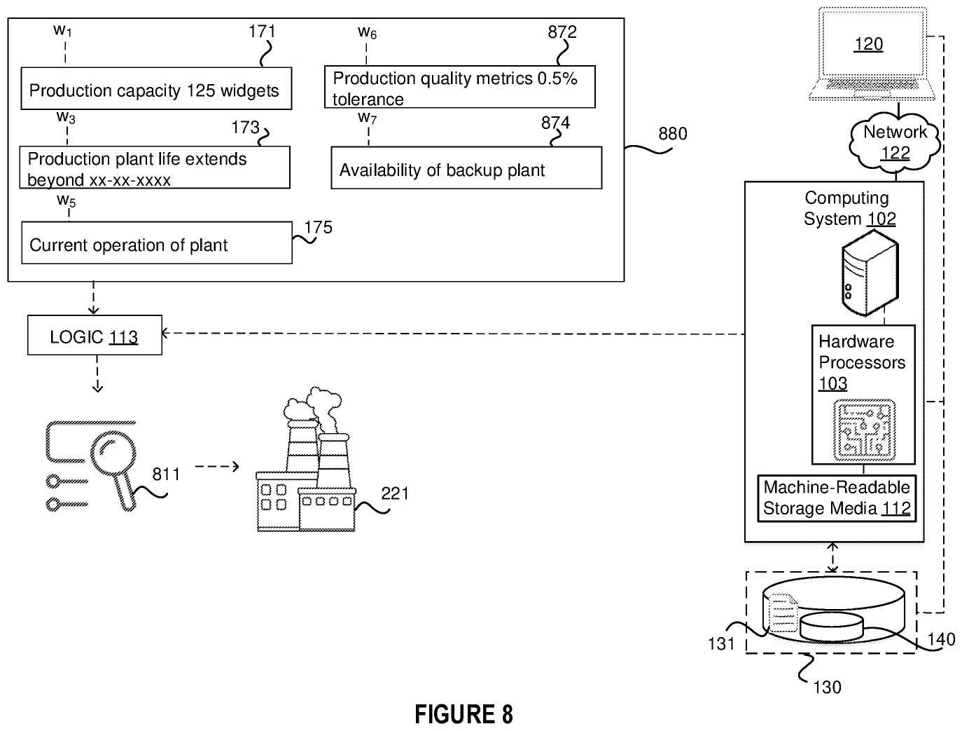

In FIG. 8, the logic 113 may receive an indication of a change in weight of one or more specifications from that in FIG. 1. This change in weight may occur during an actual execution of the workflow, in particular, while the entity is still receiving physical goods from the source 221. This change in weight may stem from an input from the entity, for example, either directly or indirectly through the computing device 120. For example, the weight w₂ of the specification 172 is illustrated in FIG. 8 as having changed to w₆, as reflected in an updated specification 872, and the weight w₄ of the specification 174 is illustrated as having change to w₇ as reflected in an updated specification 874. This changed weight may be reflected in an updated template 880. The logic 113 may perform an evaluation process 811 on the selected source 221 using the updated template 880 having the changed weights, using a same or similar process as illustrated in FIGS. 4 and 5, for example.

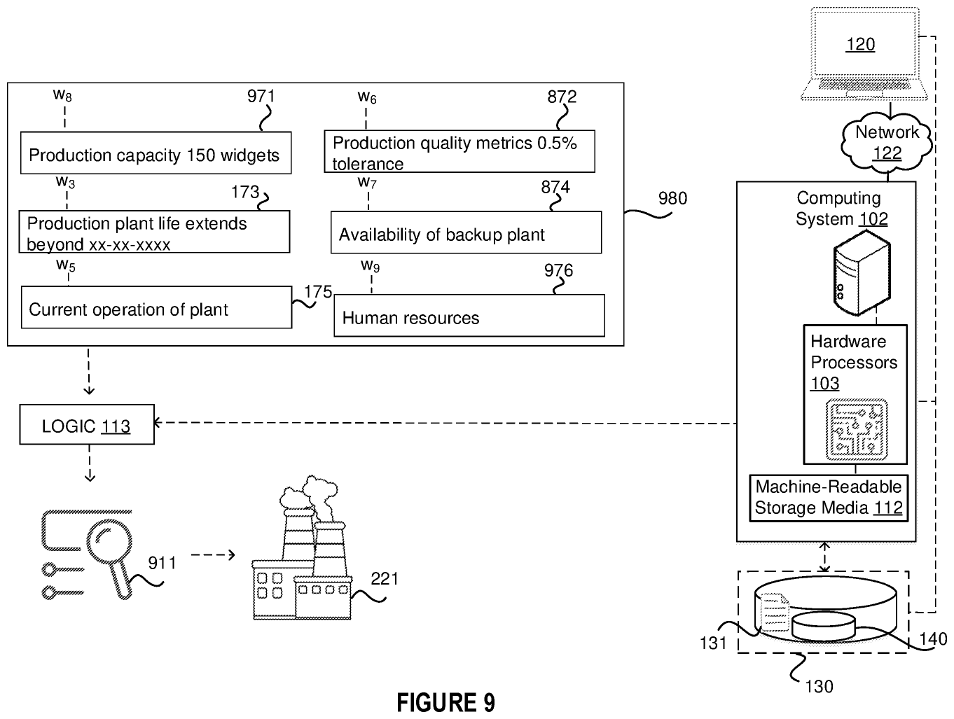

In FIG. 9, the logic 113 may receive an indication of a new specification 976 which may indicate a parameter or attribute relating to human resources, such as, a human resource requirement of the source 221. This introduction of the new specification 976 may occur during an actual execution of the workflow. Additionally, one of the previous specifications 171 may have been modified to an updated specification 971. In the example shown in FIG. 9, the updated specification 971 now indicates a production capacity of 150 widgets per month instead of 125 widgets per month. This new specification 976 and the updated specification 971 may be incorporated with the previous specifications into an updated template 980. The logic 113 may perform an evaluation process 911 on the selected source 221 using the updated template 980, using a same or similar process as illustrated in FIGS. 4 and 5, for example.

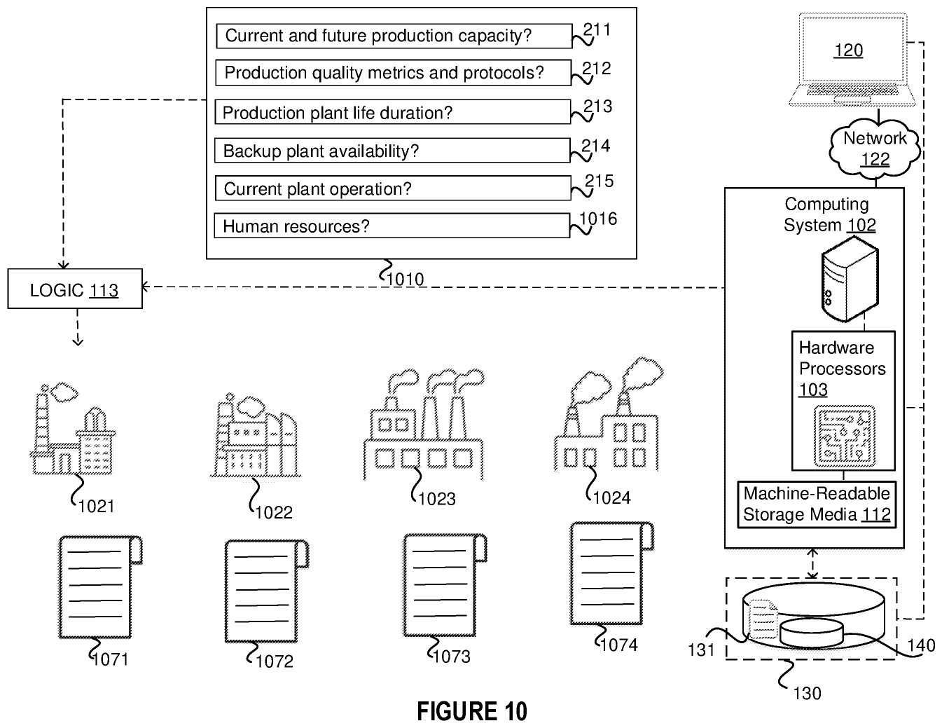

In FIG. 10, if the logic 113 determines or receives a determination that evaluation, for example, using the updated template 880 and/or 980 results in performances of the source 221 failing to meet some threshold level, then the logic 113 may determine whether other sources, such as other sources 1021, 1022, 1023, and 1024 meet this threshold level, via a same or similar process as illustrated in previous figures such as FIG. 1 and/or FIG. 2. For example, a questionnaire 1010 that includes the questions 211, 212, 213, 214, and 215, and an additional question 1016 that corresponds to the specification 976, may be utilized to obtain results 1071, 1072, 1073, and 1074 that correspond to the sources 1021, 1022, 1023, and 1024, respectively. The logic 113 may determine whether any of the results 1071, 1072, 1073, and/or 1074 meet some threshold level. If so, the logic 113 may prompt the entity to determine whether to switch to a different source, and selectively switch to a different source upon acceptance or confirmation by the entity.

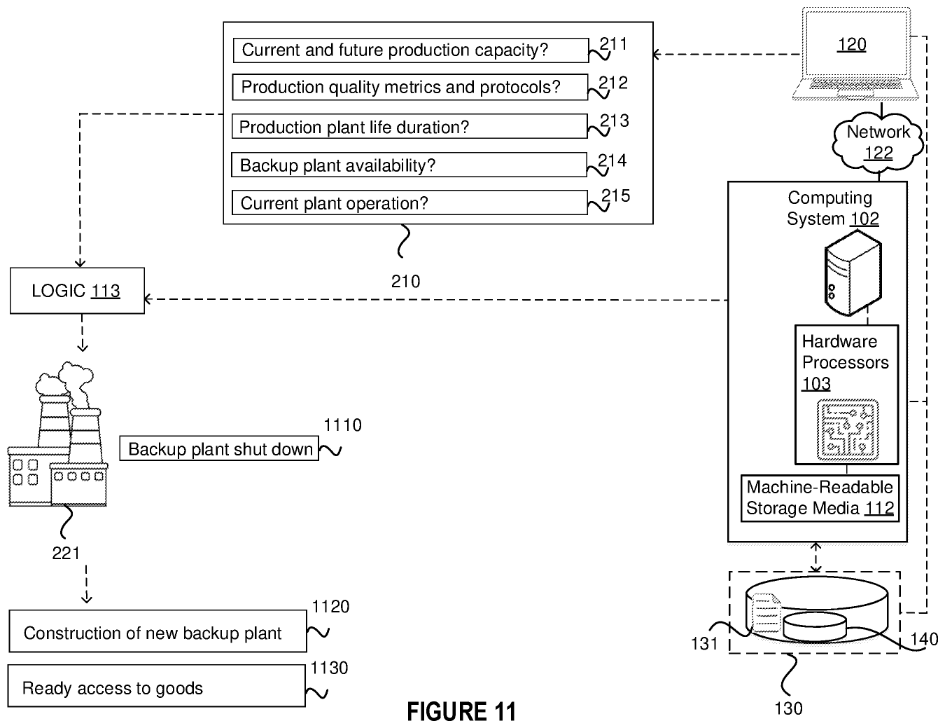

In FIG. 11, the logic 113 may receive an indication of a change in a condition or parameter of the source 221. Such a change may result in a generation of a new specification or a modification of an existing specification. For example, a change 1110 may be that a backup plant that was previously operational at the source 221 has shut down. Such a change may cause one or more new specifications 1120 and 1130 to be created or generated, such as, pertaining to construction or allocation of a new backup plant and an associated timeframe, and/or obtaining ready access to goods, in an event of a shortage. The new specifications 1120 and 1130 may be part of an updated criteria, and/or may be converted, translated, and/or assimilated into scoring criteria, to evaluate performance of the source 221. Another example change of the source 221 may include a decrease in capacity or capability of production of goods.

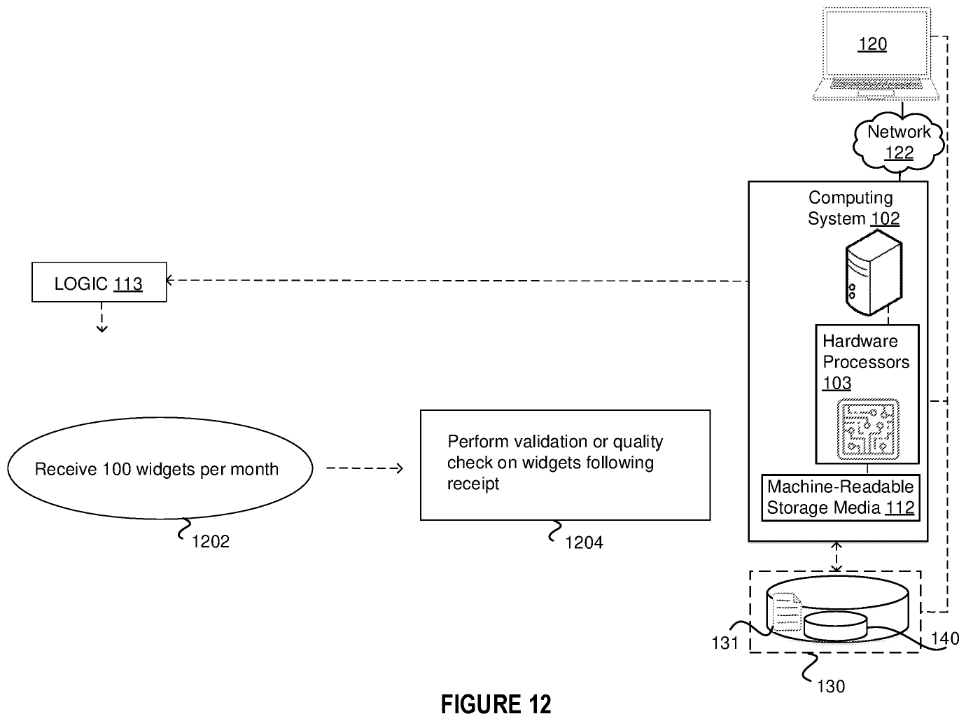

In FIG. 12, if the logic 113 may generate a workflow comprising steps 1202 and 1204. During the step 1202, the entity may receive 100 widgets per month from the source 221. During the step 1204, the entity may perform a validation or other quality control check on the received widgets following receipt, and further provide feedback to the logic 113. This feedback may be transmitted to the source 221, and/or to one or more sub-sources, and a score may be generated according to the feedback. For example, in the future, a request or a specification may include a requirement of the score as a metric. Thus, if the score falls outside of a certain bound, then the source 221 may be excluded as a potential source in response to that request.

FIG. 13 illustrates the data source 130 of the previous FIGS. 1-12 in detail. The data source 130 may be at or corresponding to a back end of the computing system 102. Stored within the data source 130 may be templates, specifications, and questionnaires corresponding to different entities such as an entity making the request 160, and information of different sources such as the source 221, or any sources or sub-sources illustrated in FIGS. 2-12. Stored within the data source 130 may be a template 1310 of a first entity. The template 1310 may include specifications 1311, 1312, and 1313 of the first entity, which may be implemented as any of the specifications 171-175 of FIGS. 1, 872 and 874 of FIGS. 8 and 9, or 971 and 976 of FIG. 9. A questionnaire 1330 generated or derived from the first entity may correspond to the template 1310 and/or any of the specifications 1311-1313. Meanwhile, a template 1320 of a second entity may include specifications 1321 and 1322. A questionnaire 1340 generated or derived from the first entity may correspond to the template 1320 and/or any of the specifications 1321 and 1322.

Stored within the data source 130 may also be information 1350 corresponding or relating to a first source specifically regarding supplying or potentially supplying goods to the first entity. The first source may correspond to any sources previously described such as the potential sources 221, 222, or 223. The information 1350 may include responses to the questionnaire 1330, an improvement summary 1352 as described in FIG. 2, and attributes or characteristics 1353 (hereinafter “characteristics”) of the first source, such as, without limitation, a production capability, a production capacity, status of facilities and/or machinery, and other entities, quantities, and types of goods that the first source is supplying to. The information 1350 may further include a scoring criteria 1354 and/or scores generated that are indicative of a performance, for example, as directed to the first entity. The scores may be indicative of an extent to which the first source is fulfilling the requests and/or desires of the first entity, and/or an extent to which the first source is complying with the specific steps or actions in the improvement summary 1352.

Similarly, information 1360 may relate to information of a sub-source that supplies or provides any components, raw goods, or goods to the first source. The information 1360 may include an improvement summary 1362, characteristics 1363 of the sub-source, and a scoring criteria 1364 and/or scores generated, for example, that are indicative of a performance of the sub-source as directed to the first entity.

Likewise, information 1370 may relate to information of the first source, specifically regarding supplying or potentially supplying goods to the second entity. The information 1370 may include responses to the questionnaire 1340, an improvement summary 1372 as described in FIG. 2, which may be similar to or same as the improvement summary 1352, characteristics 1373 of the first source, which may be same or similar to the characteristics 1353, and a scoring criteria 1374 and/or scores generated, for example, that are indicative of a performance of the first source as directed to the second entity. In some examples, the improvement summary 1372 may, compared to the improvement summary 1352, be directed or focused more towards requirements or needs of the second entity rather than the first entity.

Meanwhile, information 1380 may relate to information of a second source, specifically regarding supplying or potentially supplying goods to the first entity. The information 1380 may include responses to the questionnaire 1330, an improvement summary 1382 as described in FIG. 2, characteristics 1383 of the second source, and a scoring criteria 1384 and/or scores generated, for example, that are indicative of a performance of the second source as directed to the first entity.

Lastly, information 1390 may relate to information of a second source, specifically regarding supplying or potentially supplying goods to the second entity. The information 1390 may include responses to the questionnaire 1340, an improvement summary 1392 as described in FIG. 2, characteristics 1393 of the second source, and a scoring criteria 1394 and/or scores generated, for example, that are indicative of a performance of the second source as directed to the second entity.

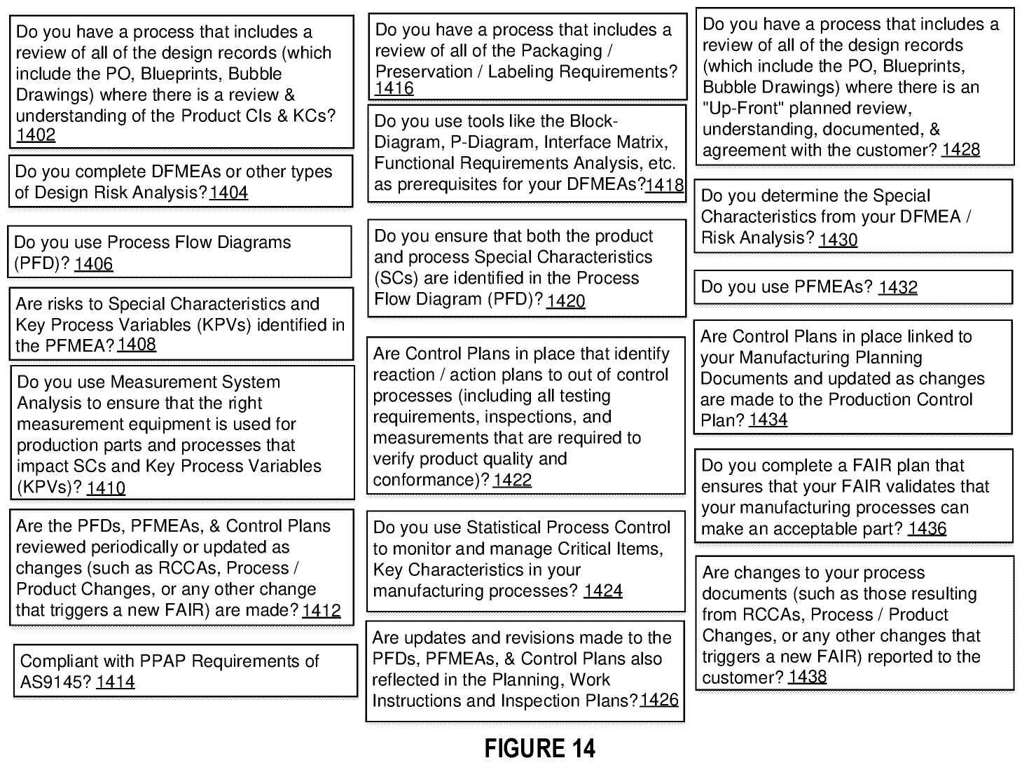

FIG. 14 illustrates a template that includes specifications or specification topics 1402, 1404, 1406, 1408, 1410, 1412, 1414, 1416, 1418, 1420, 1422, 1424, 1426, 1428, 1430, 1432, 1434, 1436, and 1438. The specifications 1402, 1404, 1406, 1408, 1410, 1412, 1414, 1416, 1418, 1420, 1422, 1424, 1426, 1428, 1430, 1432, 1434, 1436, and 1438 may all be categorized under advanced product quality planning (APQP).

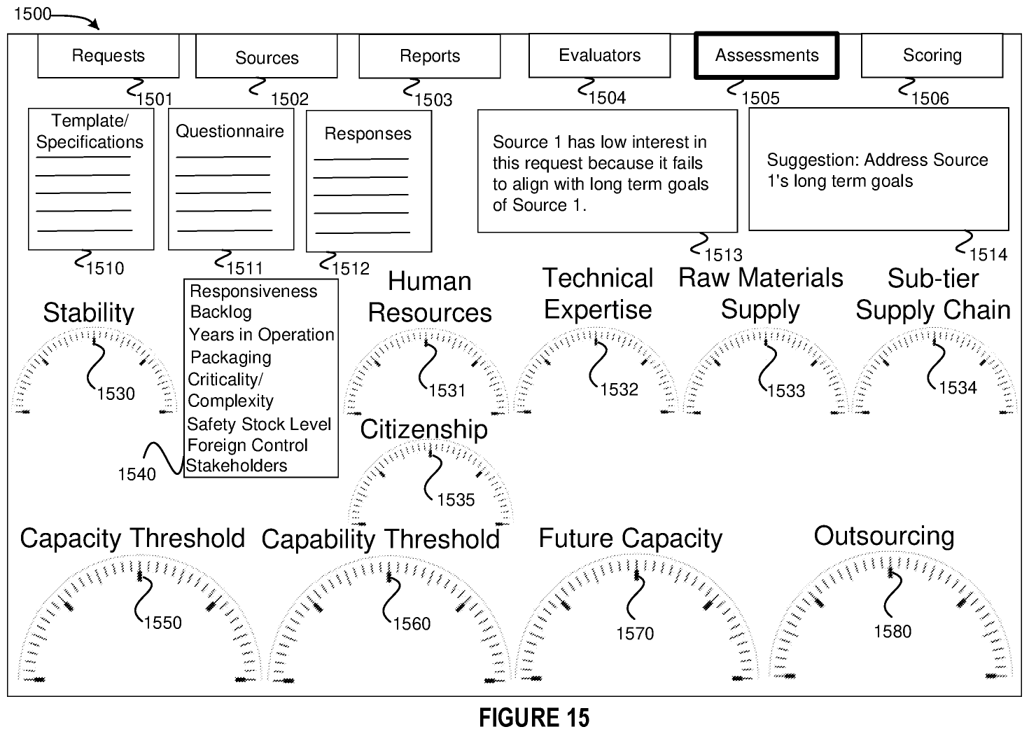

FIG. 15 illustrates an interface which may be presented, for example, at the computing device 102. An interface 1500 may include tabs 1501, 1502, 1503, 1504, 1505, and/or 1506. For example, the tab 1501 may include different requests, such as the request 160 of FIG. 1, made by an entity. By selecting the tab 1501, information regarding different requests, such as requirements or desires of each request, either current, future, or past. The information may encompass, as non-limiting examples, parameters or characteristics of each request, such as a quantity of goods, a quality parameter or condition, a deadline or schedule for receiving the goods, and/or other procedures associated with a source of the goods. In some examples, respective specifications, templates, and/or questionnaires generated or derived from the request may also be populated upon selection of the tab 1501.

The interface 1500 may further include a tab 1502 that includes information regarding different sources, such as the potential sources 221, 222, and/or 223. These different sources may include candidate or potential sources either automatically generated, requested from an corresponding to the computing device 102, and/or previously assigned to supply goods or services to the entity. This information may include locations or headquarters, years of existence, production capacities or capabilities, technical attributes or expertise, human resources, and/or any other information associated with the respective sources. The interface 1500 may further include a tab 1503 that includes previous reports related to sources. For example, the reports may indicate details of performance of different sources when supplying goods or services to the entity and/or to different entities.

The interface 1500 may further include a tab 1504 that includes information regarding one or more evaluators who may perform evaluation of different sources, such as an evaluation of performance on the request and/or an evaluation of how the sources are addressing their improvement summaries, such as the improvement summaries 281, 282, and 283. The interface 1500 may further include a tab 1505 that includes information regarding assessments of one or more sources, for example, in evaluating or predicting their abilities to fulfill the request (e.g., the request 160), and/or degrees or extents to which their attributes and/or capabilities or capacities match with the request (e.g., the request 160). The assessments may be derived or generated based on any of specifications, templates, a questionnaire, and/or responses to the questionnaire. In some examples, the assessments may also encompass information of or related to the specifications, templates, a questionnaire, and/or responses to the questionnaire. In FIG. 15, the tab 1505 corresponding to assessments is currently illustrated as being selected. The interface 1500 may further a tab 1506 that is illustrative or indicative of scoring of a source, such as while the source is supplying goods or services to the entity. The scoring may indicate a current performance of the source in addressing the request of the entity and/or in implementing an improvement summary.

The interface 1500 may further illustrate one or more templates and/or specifications 1510 specific to the entity, a questionnaire 1511 generated from the templates and/or specifications 1510, and responses from a source to the questionnaire 1511. The responses may have been inputted or ingested into the computing system 102. Additional information 1513, which may have resulted from an analysis of the source, may include a level or degree of interest and/or a degree or extent of alignment between the request and overall or long-term goals of the source. For example, if the request is related to civilian products but the source has a goal or objective of moving away from civilian products, then the request may not sufficiently align with the goal or objective of the source. In such an event, one or more additional suggestions 1514 may be outputted or generated to identify, if the entity still wishes for goods to be supplied by the source, how the entity may address the concerns of the source. For example, such additional suggestions 1514 may encompass modifying the request, and/or proposing or adding future requests that align more closely with the goal or objective of the source.

The interface 1500 may further display metrics and/or indications of performance (hereinafter “metrics”) 1530, 1531, 1532, 1533, 1534, 1535, 1550, 1560, 1570, and/or 1580. These metrics may be specific or non-specific to the template or specifications 1510 of the entity. These metrics may relate to specific categories such as stability, human resources, technical expertise, raw materials supply, sub-tier supply chain, capacity threshold, capability threshold, future capacity, and/or outsourcing. In some examples, the interface 1500 may populate sub-categories 1540 of one or more of the aforementioned categories which may affect metrics (e.g., the metric 1530) and may further display information related to metrics of one or more of the sub-categories. For example, the stability may indicate or predict a level of reliability in fulfilling the request. Next, human resources may indicate parameters or characteristics of human resources, such as experience levels, previous reviews, and/or accolades or awards received. Meanwhile, technical expertise may indicate a level of knowledge as evidenced by previous projects, either research related or fulfillments of requests, publications, presentations, and/or other outreach efforts. Next, raw materials supply may indicate a quality of, and/or a level of reliability in obtaining, raw materials. Next, sub-tier supply chain may indicate a number of other sub-sources, and a level of reliability, and/or quality associated with the sub-sources. Next, citizenship may indicate a level of environmental commitment or concern of the source, and/or a level or extent of involvement in volunteering and other social causes. A capacity threshold, as explained previously, may refer to a current operating capacity, or an amount of goods and/or services presently deliverable by a source, based, for example, based on considerations of human power, machines, and/or facilities. Meanwhile, a capability threshold may refer to an amount of goods and/or services deliverable by that source while taking into account other factors such as those related to feasibility. Those factors may encompass historical performance, solvency, and/or integrity of the source. Next, a future capacity may account for a predicted or scheduled amount of goods of a same type and/or a related or different type to different other entities within a common timeframe that the entity is scheduled to receive the goods during the current request. For example, if the request specifies a two-year duration of receiving goods, then the future capacity may determine predicted capacity within the two-year period based on other entities that are also scheduled or predicted to receive goods of a same type, similar type, or different type from the same source. The future capacity may predict backlogs and/or bottlenecks during this duration. Lastly, outsourcing may indicate a proportion of and/or a type or nature of goods that are outsourced to external sources. From the display of such information on the interface 1500, an entity may be more contextually aware and more fully informed about the specific factors of the potential and actual fulfillment of the request.

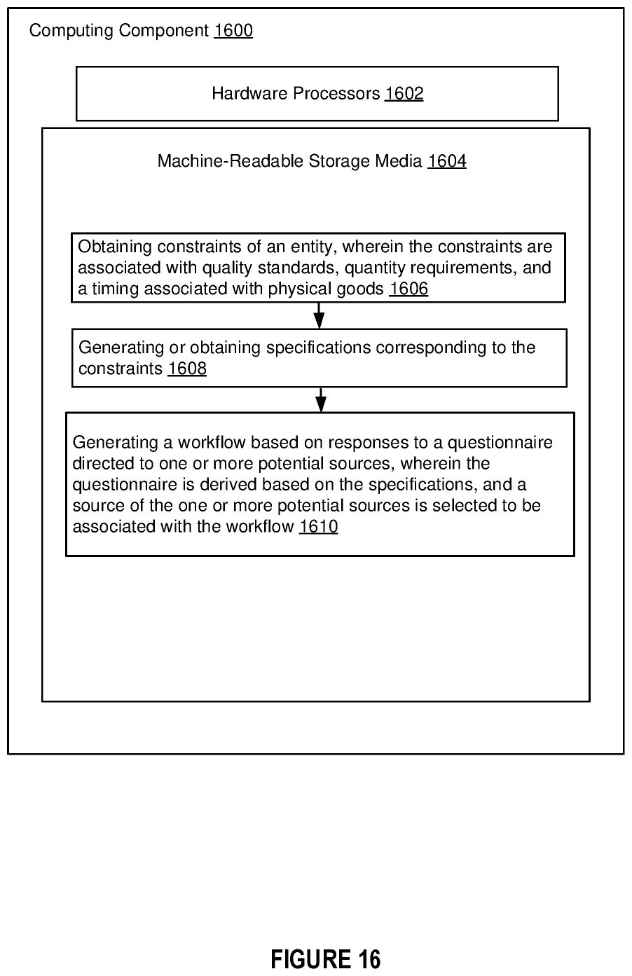

FIG. 16 illustrates a computing component 1600 that includes one or more hardware processors 1602 and machine-readable storage media 1604 storing a set of machine-readable/machine-executable instructions that, when executed, cause the hardware processor(s) 1602 to perform an illustrative method of generating a workflow.

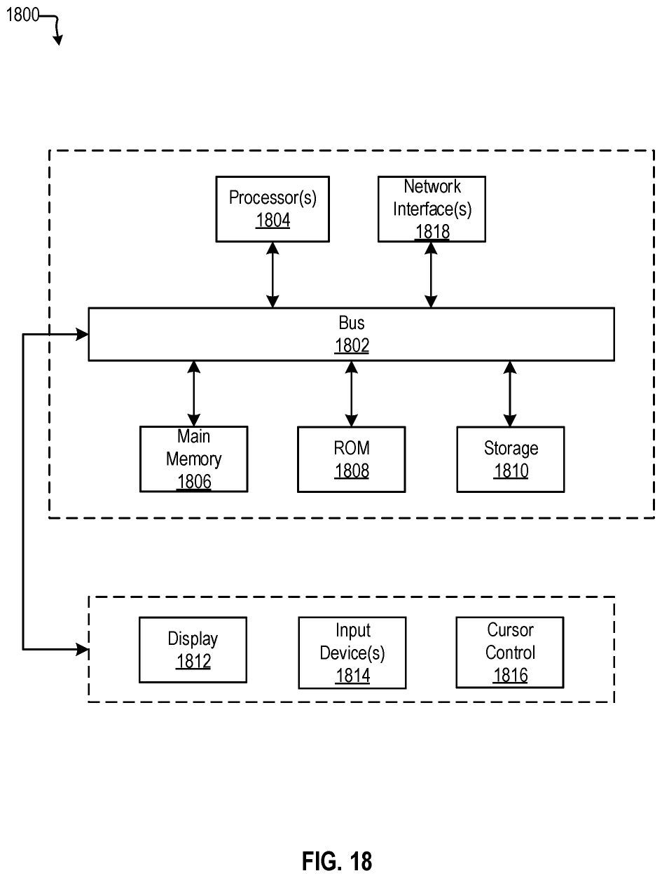

It should be appreciated that there can be additional, fewer, or alternative steps performed in similar or alternative orders, or in parallel, within the scope of the various embodiments discussed herein unless otherwise stated. The computing component 1600 may be implemented as the computing system 102 of FIGS. 1-11. The hardware processors 1602 may be implemented as the hardware processors 103 of FIGS. 1-12. The machine-readable storage media 1604 may be implemented as the machine-readable storage media 112 of FIGS. 1-12, and may include suitable machine-readable storage media described in FIG. 18.

At step 1606, the hardware processor(s) 1602 may execute machine-readable/machine-executable instructions stored in the machine-readable storage media 1604 to obtain constraints of an entity, wherein the constraints are associated with quality standards, quantity requirements, and a timing associated with physical goods, for example, as specified by the request 160 of FIG. 1.

At step 1608, the hardware processor(s) 1602 may execute machine-readable/machine-executable instructions stored in the machine-readable storage media 1604 to generate or obtain specifications (e.g., the specifications 171-175 of FIG. 1) corresponding to the constraints. These specifications may be used to derive or formulate a questionnaire. This questionnaire may be given or provided to one or more potential sources (e.g., the potential sources 221, 222, 223 of FIG. 2) to select a particular potential source that provides responses (e.g., the responses 271, 272, 273) that fit the specifications 171-175, and/or the template 180) to a closest extent or degree.

At step 1610, the hardware processor(s) 1602 may execute machine-readable/machine-executable instructions stored in the machine-readable storage media 1604 to generate a workflow based on the responses to the questionnaire. The particular potential source may be associated with the workflow by provisioning of the physical goods 161 according to the specifications 171-175.

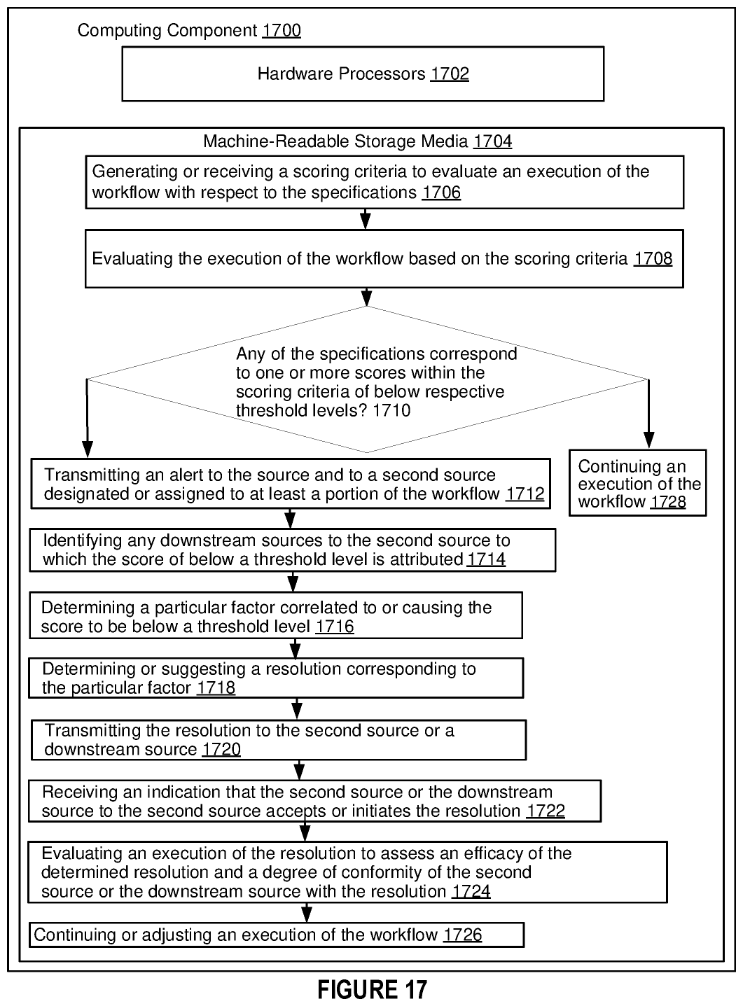

FIG. 17 illustrates a computing component 1700 that includes one or more hardware processors 1702 and machine-readable storage media 1704 storing a set of machine-readable/machine-executable instructions that, when executed, cause the hardware processor(s) 1702 to perform an illustrative method of generating a workflow.

It should be appreciated that there can be additional, fewer, or alternative steps performed in similar or alternative orders, or in parallel, within the scope of the various embodiments discussed herein unless otherwise stated. The computing component 1700 may be implemented as the computing system 102 of FIGS. 1-11. The hardware processors 1702 may be implemented as the hardware processors 103 of FIGS. 1-12. The machine-readable storage media 1704 may be implemented as the machine-readable storage media 112 of FIGS. 1-12, and may include suitable machine-readable storage media described in FIG. 18.

At step 1706, the hardware processor(s) 1702 may execute machine-readable/machine-executable instructions stored in the machine-readable storage media 1704 to generate or receive a scoring criteria to evaluate an execution of the workflow with respect to the specifications (e.g., the specifications 171-175 of FIG. 1).

At step 1708, the hardware processor(s) 1702 may execute machine-readable/machine-executable instructions stored in the machine-readable storage media 1704 to evaluate the execution of the workflow based on the scoring criteria.

At decision 1710, the hardware processor(s) 1702 may execute machine-readable/machine-executable instructions stored in the machine-readable storage media 1704 to determine whether any of the specifications correspond to one or more scores within the scoring criteria of below respective threshold levels. For example, a specification may refer to a quality standard and may correspond to a detected quality metric falling below a threshold level.

At step 1712, in response to a positive determination at decision 1710, the hardware processor(s) 1702 may execute machine-readable/machine-executable instructions stored in the machine-readable storage media 1704 to transmit an alert to the source (e.g., the source 221) and to any second source designated or assigned to at least a portion of the workflow (e.g., the sub-source 321).

At step 1714, the hardware processor(s) 1702 may execute machine-readable/machine-executable instructions stored in the machine-readable storage media 1704 to identify any downstream sources (e.g., the sub-sub source 341) to the second source to which the score of below a threshold level is attributed. For example, a quality issue or a quantity issue may be due to inadequate and/or faulty raw materials supplied by the sub-sub-source 341.

At step 1716, the hardware processor(s) 1702 may execute machine-readable/machine-executable instructions stored in the machine-readable storage media 1704 to determine a particular factor (e.g., quality or quantity) correlated to or causing the score to be below a threshold level.

At step 1718, the hardware processor(s) 1702 may execute machine-readable/machine-executable instructions stored in the machine-readable storage media 1704 to determine or suggest a resolution corresponding to the particular factor. Such a determination or suggestion may be based on historical actions implemented in response to similar and/or same issues associated with the score being below the threshold level, either implemented at the same source or at a different source, which may have resulted in resolution of the issues.

At step 1720, the hardware processor(s) 1702 may execute machine-readable/machine-executable instructions stored in the machine-readable storage media 1704 to transmit the resolution to the second source or a downstream source.

At step 1722, the hardware processor(s) 1702 may execute machine-readable/machine-executable instructions stored in the machine-readable storage media 1704 to receive an indication that the second source or the downstream source to the second source accepts or initiates the resolution.

At step 1724, the hardware processor(s) 1702 may execute machine-readable/machine-executable instructions stored in the machine-readable storage media 1704 to evaluate an execution of the resolution to assess an efficacy of the determined resolution and a degree of conformity of the second source or the downstream source with the resolution.

At step 1726, the hardware processor(s) 1702 may execute machine-readable/machine-executable instructions stored in the machine-readable storage media 1704 to continue or adjusting an execution of the workflow. For example, if the evaluation of the execution in step 1724 indicates that the resolution was adequately, sufficiently, or successfully implemented, then the hardware processor(s) 1702 may continue an execution of the workflow. Otherwise, the hardware processor(s) 1702 may adjust an execution of the workflow, for example, by changing the source, the second source, and/or the downstream source, and/or adding another source into the workflow, for example, to supply or produce additional goods, intermediate components, or raw materials. In some examples, the adjustment of the execution of the workflow may encompass an action in accordance with an improvement summary (e.g., the improvement summary 281), or, if an action has already been implemented or attempted, switching to a different action in accordance with the improvement summary. For example, if the resolution, intended to address a supply shortage, was initially to open a backup facility or plant, but such a resolution failed to address the supply shortage, then the resolution may be switched to a different action such as increasing an output from a current facility or plant.

At step 1728, in response to a negative determination at decision 1710, the hardware processor(s) 1702 may execute machine-readable/machine-executable instructions stored in the machine-readable storage media 1704 to continue an execution of the workflow.

### Hardware Implementation

The techniques described herein are implemented by one or more special-purpose computing devices. The special-purpose computing devices may be hard-wired to perform the techniques, or may include circuitry or digital electronic devices such as one or more application-specific integrated circuits (ASICs) or field programmable gate arrays (FPGAs) that are persistently programmed to perform the techniques, or may include one or more hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques.

Computing device(s) are generally controlled and coordinated by operating system software. Operating systems control and schedule computer processes for execution, perform memory management, provide file system, networking, I/O services, and provide a user interface functionality, such as a graphical user interface (“GUI”), among other things.

FIG. 18 is a block diagram that illustrates a computer system 1800 upon which any of the embodiments described herein may be implemented. In some examples, the computer system 1800 may include a cloud-based or remote computing system. For example, the computer system 1800 may include a cluster of machines orchestrated as a parallel processing infrastructure. The computer system 1800 includes a bus 1802 or other communication mechanism for communicating information, one or more hardware processors 1804 coupled with bus 1802 for processing information. Hardware processor(s) 1804 may be, for example, one or more general purpose microprocessors.

The computer system 1800 also includes a main memory 1806, such as a random access memory (RAM), cache and/or other dynamic storage devices, coupled to bus 1802 for storing information and instructions to be executed by processor 1804. Main memory 1806 also may be used for storing temporary variables or other intermediate information during execution of instructions to be executed by processor 1804. Such instructions, when stored in storage media accessible to processor 1804, render computer system 1800 into a special-purpose machine that is customized to perform the operations specified in the instructions.

The computer system 1800 further includes a read only memory (ROM) 1808 or other static storage device coupled to bus 1802 for storing static information and instructions for processor 1804. A storage device 1810, such as a magnetic disk, optical disk, or USB thumb drive (Flash drive), etc., is provided and coupled to bus 1802 for storing information and instructions.

The computer system 1800 may be coupled via bus 1802 to a display 1812, such as a cathode ray tube (CRT) or LCD display (or touch screen), for displaying information to a computer user. An input device 1814, including alphanumeric and other keys, is coupled to bus 1802 for communicating information and command selections to processor 1804. Another type of user input device is cursor control 1816, such as a mouse, a trackball, or cursor direction keys for communicating direction information and command selections to processor 1804 and for controlling cursor movement on display 1812. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

The computing system 1800 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “module,” as used herein, refers to logic embodied in hardware or firmware, or to a collection of software instructions, possibly having entry and exit points, written in a programming language, such as, for example, Java, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules or computing device functionality described herein are preferably implemented as software modules, but may be represented in hardware or firmware. Generally, the modules described herein refer to logical modules that may be combined with other modules or divided into sub-modules despite their physical organization or storage.

The computer system 1800 may implement the techniques described herein using customized hard-wired logic, one or more ASICs or FPGAs, firmware and/or program logic which in combination with the computer system causes or programs computer system 1800 to be a special-purpose machine. According to one embodiment, the techniques herein are performed by computer system 1800 in response to processor(s) 1804 executing one or more sequences of one or more instructions contained in main memory 1806. Such instructions may be read into main memory 1806 from another storage medium, such as storage device 1810. Execution of the sequences of instructions contained in main memory 1806 causes processor(s) 1804 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1810. Volatile media includes dynamic memory, such as main memory 1806. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1802. Transmission media can also take the form of acoustic or light waves, such as those generated during radio-wave and infra-red data communications.

Various forms of media may be involved in carrying one or more sequences of one or more instructions to processor 1804 for execution. For example, the instructions may initially be carried on a magnetic disk or solid state drive of a remote computer. The remote computer can load the instructions into its dynamic memory and send the instructions over a telephone line using a modem. A modem local to computer system 1800 can receive the data on the telephone line and use an infra-red transmitter to convert the data to an infra-red signal. An infra-red detector can receive the data carried in the infra-red signal and appropriate circuitry can place the data on bus 1802. Bus 1802 carries the data to main memory 1806, from which processor 1804 retrieves and executes the instructions. The instructions received by main memory 1806 may retrieves and executes the instructions. The instructions received by main memory 1806 may optionally be stored on storage device 1810 either before or after execution by processor 1804.

The computer system 1800 also includes a communication interface 1818 coupled to bus 1802. Communication interface 1818 provides a two-way data communication coupling to one or more network links that are connected to one or more local networks. For example, communication interface 1818 may be an integrated services digital network (ISDN) card, cable modem, satellite modem, or a modem to provide a data communication connection to a corresponding type of telephone line. As another example, communication interface 1818 may be a local area network (LAN) card to provide a data communication connection to a compatible LAN (or WAN component to communicated with a WAN). Wireless links may also be implemented. In any such implementation, communication interface 1818 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet”. Local network and Internet both use electrical, electromagnetic or optical signals that carry digital data streams. The signals through the various networks and the signals on network link and through communication interface 1818, which carry the digital data to and from computer system 1800, are example forms of transmission media.

The computer system 1800 can send messages and receive data, including program code, through the network(s), network link and communication interface 1818. In the Internet example, a server might transmit a requested code for an application program through the Internet, the ISP, the local network and the communication interface 1818.

The received code may be executed by processor 1804 as it is received, and/or stored in storage device 1810, or other non-volatile storage for later execution.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be removed, executed out of order from that shown or discussed, including substantially concurrently or in reverse order, depending on the functionality involved, as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

It will be appreciated that “logic,” a “system,” “data store,” and/or “database” may comprise software, hardware, firmware, and/or circuitry. In one example, one or more software programs comprising instructions capable of being executable by a processor may perform one or more of the functions of the data stores, databases, or systems described herein. In another example, circuitry may perform the same or similar functions. Alternative embodiments may comprise more, less, or functionally equivalent systems, data stores, or databases, and still be within the scope of present embodiments. For example, the functionality of the various systems, data stores, and/or databases may be combined or divided differently.

“Open source” software is defined herein to be source code that allows distribution as source code as well as compiled form, with a well-publicized and indexed means of obtaining the source, optionally with a license that allows modifications and derived works.

The data stores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

As used herein, the term “or” may be construed in either an inclusive or exclusive sense. Moreover, plural instances may be provided for resources, operations, or structures described herein as a single instance. Additionally, boundaries between various resources, operations, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Although the invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any figure or example can be combined with one or more features of any other figure or example. A component being implemented as another component may be construed as the component being operated in a same or similar manner as the another component, and/or comprising same or similar features, characteristics, and parameters as the another component.

The phrases “at least one of,” “at least one selected from the group of,” or “at least one selected from the group consisting of,” and the like are to be interpreted in the disjunctive (e.g., not to be interpreted as at least one of A and at least one of B).

Reference throughout this specification to an “example” or “examples” means that a particular feature, structure or characteristic described in connection with the example is included in at least one example of the present invention. Thus, the appearances of the phrases “in one example” or “in some examples” in various places throughout this specification are not necessarily all referring to the same examples, but may be in some instances. Furthermore, the particular features, structures, or characteristics may be combined in any suitable manner in one or more different examples.

1. A computing system, comprising:
one or more processors; and
memory storing instructions that, when executed by the one or more processors, cause the system to perform:
obtaining constraints of an entity, wherein the constraints are associated with quality standards, quantity requirements, and a timing characteristic associated with physical goods;
generating or obtaining specifications corresponding to the constraints; and
generating a workflow based on responses to a questionnaire directed to one or more potential sources, wherein the questionnaire is derived based on the specifications, and a source of the one or more potential sources is selected to be associated with the workflow.

2. The computing system of claim 1, wherein the specifications comprise desired or required conditions or guidelines to be conformed to for the entity, or categories associated with the desired or required conditions.

3. The computing system of claim 1, wherein the instructions further cause the system to perform:
compiling the specifications into a template, wherein the template is linked specifically to the workflow and to the entity.

4. The computing system of claim 1, wherein the instructions further cause the system to perform:
generating or receiving a scoring criteria to evaluate an execution of the workflow with respect to the specifications, wherein the scoring criteria indicates a degree of conformance of the execution of the workflow to the specifications; and
evaluating the execution of the workflow based on the scoring criteria.

5. The computing system of claim 4, wherein the instructions further cause the system to perform:
determining any of the specifications corresponding to one or more scores within the scoring criteria of below respective threshold levels; and
in response to the determination of the any of the specifications corresponding to one or more scores within the scoring criteria of below respective threshold levels, transmitting an alert to the source and to a second source designated or assigned to at least a portion of the workflow.

6. The computing system of claim 5, wherein the instructions further cause the system to perform:
in response to transmitting the alert, identifying any downstream sources to the second source to which the score of below a threshold level is attributed.

7. The computing system of claim 5, wherein the instructions further cause the one or more processors to perform:
determining a particular factor correlated to or causing the score to be below a threshold level;
determining or suggesting a resolution corresponding to the particular factor; and
transmitting the resolution to the second source or a downstream source.

8. The computing system of claim 7, wherein the instructions further cause the one or more processors to perform:
receiving an indication that the second source or the downstream source to the second source accepts or initiates the resolution; and
evaluating an execution of the resolution to assess an efficacy of the determined resolution and a degree of conformity of the second source or the downstream source with the resolution.

9. The computing system of claim 1, wherein the instructions further cause the one or more processors to perform:
determining or receiving a modification of a specification of the specifications;
reflecting the modification within the template;
accordingly updating the scoring criteria based on the modification; and
evaluating an execution of the workflow based on the updated scoring criteria.

10. The computing system of claim 1, wherein the instructions further cause the one or more processors to perform:
receiving an update to a weight corresponding to one of the specifications; and
evaluating an execution of the workflow based on the update to the weight.

11. A computer-implemented method, the method comprising:
obtaining constraints of an entity, wherein the constraints are associated with quality standards, quantity requirements, and a timing characteristic associated with physical goods;
generating or obtaining specifications corresponding to the constraints; and
generating a workflow based on responses to a questionnaire directed to one or more potential sources, wherein the questionnaire is derived based on the specifications, and a source of the one or more potential sources is selected to be associated with the workflow.

12. The computer-implemented method of claim 11, wherein the specifications comprise desired or required conditions or guidelines to be conformed to for the entity, or categories associated with the desired or required conditions.

13. The computer-implemented method of claim 11, further comprising:
compiling the specifications into a template, wherein the template is linked specifically to the workflow and to the entity.

14. The computer-implemented method of claim 11, further comprising:
generating or receiving a scoring criteria to evaluate an execution of the workflow with respect to the specifications, wherein the scoring criteria indicates a degree of conformance of the execution of the workflow to the specifications; and
evaluating the execution of the workflow based on the scoring criteria.

15. The computer-implemented method of claim 14, further comprising:
determining any of the specifications corresponding to one or more scores within the scoring criteria of below respective threshold levels; and
in response to the determination of the any of the specifications corresponding to one or more scores within the scoring criteria of below respective threshold levels, transmitting an alert to the source and to a second source designated or assigned to at least a portion of the workflow.

16. The computer-implemented method of claim 15, further comprising:
identifying any downstream sources to the second source to which the score of below a threshold level is attributed.

17. The computer-implemented method of claim 15, further comprising:
determining a particular factor correlated to or causing the score to be below a threshold level;
determining or suggesting a resolution corresponding to the particular factor; and
transmitting the resolution to the second source or a downstream source.

18. The computer-implemented method of claim 17, further comprising:
receiving an indication that the second source or the downstream source to the second source accepts or initiates the resolution; and
evaluating an execution of the resolution to assess an efficacy of the determined resolution and a degree of conformity of the second source or the downstream source with the resolution.

19. The computer-implemented method of claim 11, further comprising:
determining or receiving a modification of a specification of the specifications;
reflecting the modification within the template;
accordingly updating the scoring criteria based on the modification; and
evaluating an execution of the workflow based on the updated scoring criteria.

20. The computer-implemented method of claim 11, further comprising:
receiving an update to a weight corresponding to one of the specifications; and
evaluating an execution of the workflow based on the update to the weight.
